(19) United States
(12) Patent Application Publication
(10) Pub. No.: US 2010/0329646 A1
(43) Pub. Date: Dec. 30, 2010

(54) SYSTEM AND METHOD FOR REMOTE FILM COLOR CORRECTION

(76) Inventor: MARKUS E. LOEFFLER, Alhambra, CA (US)

Correspondence Address: Robert D. Shedd, Patent Operations;THOMSON Licensing LLC, P.O. Box 5312, Princeton, NJ, 08543-5312, US

(21) Appl. No.: 12/492,582

(22) Filed: Jun. 26, 2009

(51) Int. Cl. H04N 9/79; G06K 9/00

(52) U.S. Cl. 386/300; 382/167; 386/E09.001

(57) ABSTRACT

A system and method for remote film color correction are provided. The system and method provide for capturing at least one scene on a film negative at a first location (202), scanning at least two frames from the at least one scene on the film negative at a second location (206), transmitting the at least two frames to a network accessible storage device (208), accessing the at least two frames by a computing device at the first location (210), grading at least one frame of the at least two frames on the computing device (212), generating metadata relating to the at least one frame based on the grading step (214), and transmitting the generated metadata to the second location (216). The remote color correction system and method is designed to be used for dailies processing. The system and method generates color correction metadata that is sent to a dailies facility via e-mail/Internet, i.e., a computer network communication.

### TECHNICAL FIELD OF THE INVENTION

The present disclosure generally relates to film production processing and display systems, and more particularly, to a system and method for remote film color correction.

### BACKGROUND OF THE INVENTION

Initially, in the motion picture industry, an original motion picture negative film is exposed during a camera exposure operation, developed into a processed camera negative and subsequently operated upon in one of several ways to produce an imagery product. In such conventional analog systems, film dailies or rushes were produced as a motion picture was shot. These dailies or rushes were processed and then viewed by the director, the producer, the film editor, etc. working on the production to determine whether the scenes shot were acceptable. Each person on the production team assessed the dailies for different elements relevant to their respective roles in the team. The cinematographers and directors could see the results of the previous day's work in a format that faithfully “previewed” what the final release could look like.

Generally, in creating dailies, raw, unedited footage is developed, synched to sound, and printed on film in a batch. The conventional implementation of analog film dailies is, after the first day of shooting, the Director of Photography goes to a lab to set basic printer lights/color corrections and communicate the desired looks to the color timer/colorist. These looks would then be used for the dailies transfers for the entire production. Currently, there is no system for the Director of Photography on set to do color corrections himself. The only option is to look at dailies tapes/prints the next day and to verbally describe color modifications to the color timer/colorist in case major modifications were needed. Driving back and forth between an on-set location and the developing lab or dailies facility takes too much time or is not possible at all because of distance.

One conventional system enables on-set look management through a digital still camera, e.g., a digital SLR camera, that is attached to a 35 mm film camera capturing a scene. The digital still camera is calibrated to emulate the negative. A special test chart, e.g., similar to a Macbeth color chart, has to be filmed to match images between the film camera and digital SLR camera. Color correction may then be performed on the images taken by the digital SLR camera. However, the resulting color correction is typically not satisfactory due to several factor including, but not limited to, the image on the still camera is not the real image on the film, different framing, different lens systems, different graining, and a different color space for each camera.

Therefore, a need exists for techniques for on-set or remote color correction of film dailies.

### SUMMARY

The present disclosure provides a system and method for remote film color correction. The remote film color correction system and method is designed to be used for dailies processing. The system and method enables the Director of Photography (DP/DIT) to do primary color correction on a computing device, e.g., a laptop, with a calibrated monitor at a remote location, e.g., remote from a dailies facility. The Director of Photography (DP/DIT) accesses or retrieves scanned images of an originally film captured scene via FTP/Internet, i.e., a computer network communication, at the remote location. The system and method then generates color correction meta-data that is sent back to the dailies facility via e-mail/Internet, i.e., a computer network communication.

According to one aspect of the present disclosure, a method for remote film color correction is provided, the method including capturing at least one scene on a film negative at a first location, scanning at least two frames from each at least one scene on the film negative at a second location, transmitting the at least two frames to a network accessible storage device, accessing the at least two frames by a computing device at the first location, grading at least one frame of the at least two frames on the computing device, generating metadata relating to the at least one frame based on the grading step, and transmitting the generated metadata to the second location.

In a further aspect, the grading step further comprises applying a lookup table including a film print emulation to the at least one frame on the computing device.

In one aspect, the metadata includes RGB values for offset, RGB values for power, RGB values for slope and a saturation value. In another aspect, the metadata is in ASC CDL format.

In yet another aspect, the method further includes applying the generated metadata to the at least two frames from each at least one scene at the second location.

In a further aspect, the transmitting the generated metadata is performed by e-mail or an FTP transfer.

According to another aspect of the present disclosure, a system for remote film color correction includes means for accessing over a network at least two frames of at least one scene, the at least two frames being scanned from a film negative including each of the at least one scene, a display device for displaying at least one frame of the at least two frames, a color grader for grading the at least one frame of the at least two frames, a metadata generator for generating metadata relating to the at least one frame based on color correction values received from the color grader, and means for transmitting the generated metadata over the network to a storage device.

According to a further aspect of the present disclosure, a program storage device readable by a machine, tangibly embodying a program of instructions executable by the machine to perform method steps for remote film color correction is provided, the method including accessing over a network at least two frames of at least one scene, the at least two frames being scanned from a film negative including each of the at least one scene, displaying on a display device at least one frame of the at least two frames, grading the at least one frame of the at least two frames, generating metadata relating to the at least one frame based the grading step, and transmitting the generated metadata over the network to a storage device.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 illustrates a workflow diagram for remote film color correction according to an aspect of the present disclosure;

FIG. 2 is an exemplary illustration of a system for remote film color correction according to an aspect of the present disclosure;

FIG. 3 is a flow diagram of an exemplary method for remote film color correction according to an aspect of the present disclosure; and

FIG. 4 illustrates an exemplary screen shot for color correcting at least one frame of a scene according to an aspect of the present disclosure.

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure provides a system and method for remote film color correction. The remote color correction system and method is based on preview and inspection software for Digital Picture Exchange (DPX) files, i.e., scanned digital images of frames. The system and method provide for reading 10 bit DPX-frames, applying a three dimensional look-up table (3D LUT) containing a film print emulation and adding primary color correction (preferably American Society of Cinematographers color decision list (ASC-CDL) defined manipulations) to the image or,frame. In combination with a proper calibrated display (using International Color Consortium (ICC) profiles), the system and method of the present disclosure provides a good reference for dailies, editorials and Digital Intermediates (DI) at a location remote from the dailies facility.

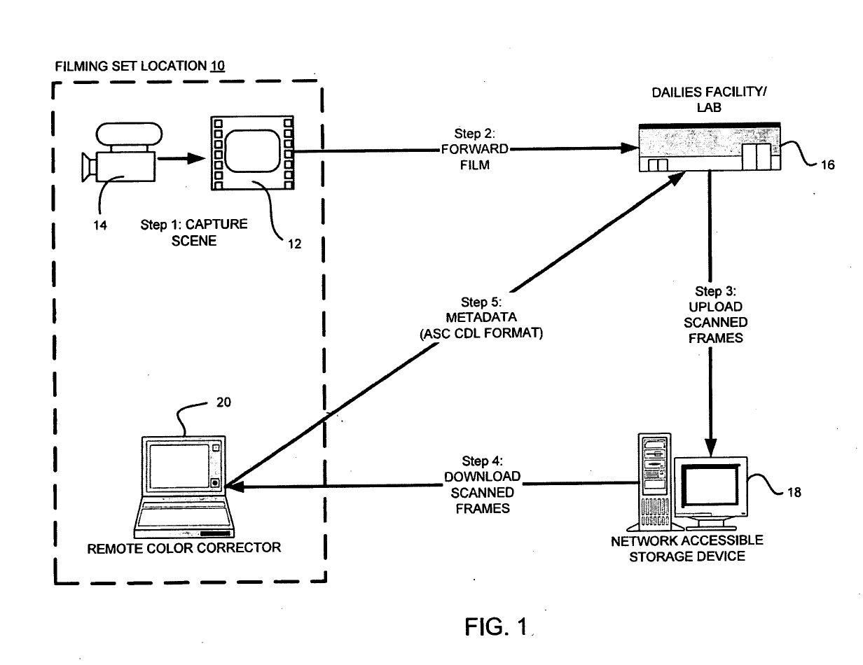

Referring to FIG. 1, a general workflow diagram for remote film color correction according to an aspect of the present disclosure is provided. The workflow shown is generally applicable to every shoot day on a filming set location 10. Initially, in step 1, a scene or shot is captured on film 12 via a film camera 14. In one embodiment, the scene is shot or captured on 35 mm film. In step 2, the camera negative gets forwarded or delivered to a lab 16 to be developed. For each camera roll and for each scene/take/setup, several images get scanned and uploaded to an FTP location or other network accessible storage device 18, such as a server (step 3). It is to be appreciated that the scanning and uploading of the images may be done at the lab 16 or at a separate facility, e.g., a dailies facility, where the developed images are further processed.

In step 4, the Director of Photography (DP) downloads the scanned images at the filming set location 10 and starts grading at least one frame per scene on a remote color corrector 20, e.g., a laptop computer. After grading only the color correction meta-data (e.g., in an ASC CDL format) is sent back to the dailies facility via e-mail or other network protocol. In the dailies facility, the metadata (and optionally, a 3D lookup table) is applied to each scene and transferred to tape/DVD/etc for editorial. The color correction metadata can also be used in final color correction.

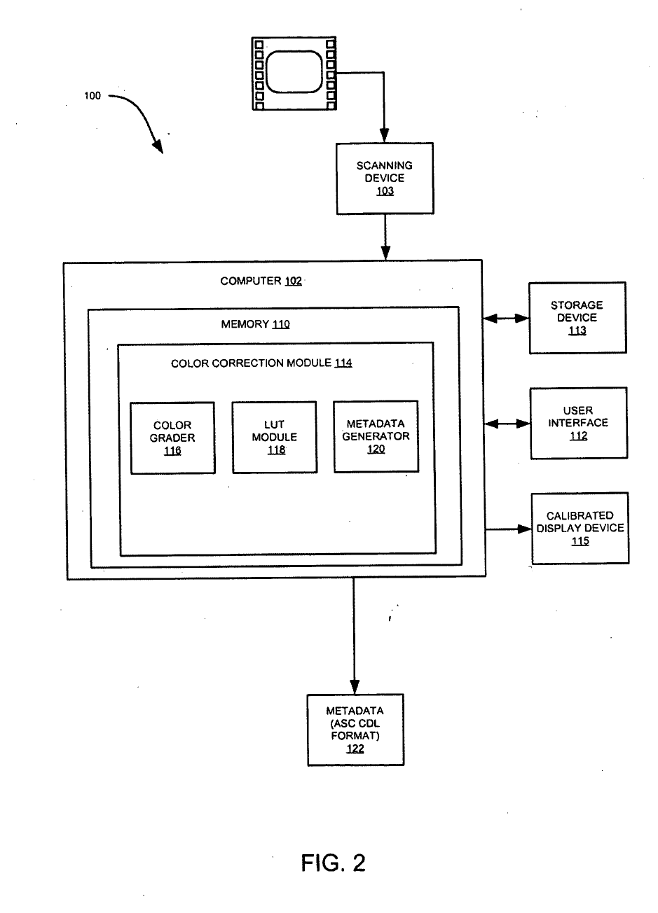

Referring now to FIG. 2, an exemplary system 100 according to an embodiment of the present disclosure is shown. A scanning device 103 may be provided for scanning film prints, e.g., camera-original film negatives, into a digital format, e.g. Cineon-format or Society of Motion Picture and Television Engineers (SMPTE) Digital Picture Exchange (DPX) files. The scanning device 103 may comprise, e.g., a telecine or any device that will generate a video output from film such as, e.g., a Spirit™ HD scanner with video output. Scanned film prints or frames are input to a post-processing device 102, e.g., a computer. It is to be appreciated that the scanning device 103 is located remotely from the post-processing device 102 and the scanned film prints or frames are electronically transmitted to the post-processing device 102 over a network, as will be described in more detail below.

The post-processing or computing device 102, also shown as the remote color corrector in FIG. 1, is implemented on any of the various known computer platforms having hardware such as one or more central processing units (CPU), memory 110 such as random access memory (RAM) and/or read only memory (ROM) and input/output (I/O) user interface(s) 112 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In one embodiment, the software application program is tangibly embodied on a program storage device, which may be uploaded to and executed by any suitable machine such as post-processing device 102. In addition, various other peripheral devices may be connected to the computer platform by various interfaces and bus structures, such a parallel port, serial port or universal serial bus (USB). Other peripheral devices may include additional storage devices 113 and a printer. The printer may be employed for printed a revised version of the scanned film.

A calibrated display device 115 is coupled to the post-processing or computing device 102. Depending on the quality of the display device, the display device 15 may be an external monitor or an internal display of for example a laptop. The calibration is performed in the form of an ICC profile. In color management, an ICC profile is a set of data that characterizes a color input or output device, or a color space, according to standards promulgated by the ICC. ICC profiles describe the color attributes of a particular device or viewing requirement by defining a mapping between the device source or target color space and a profile connection space (PCS).

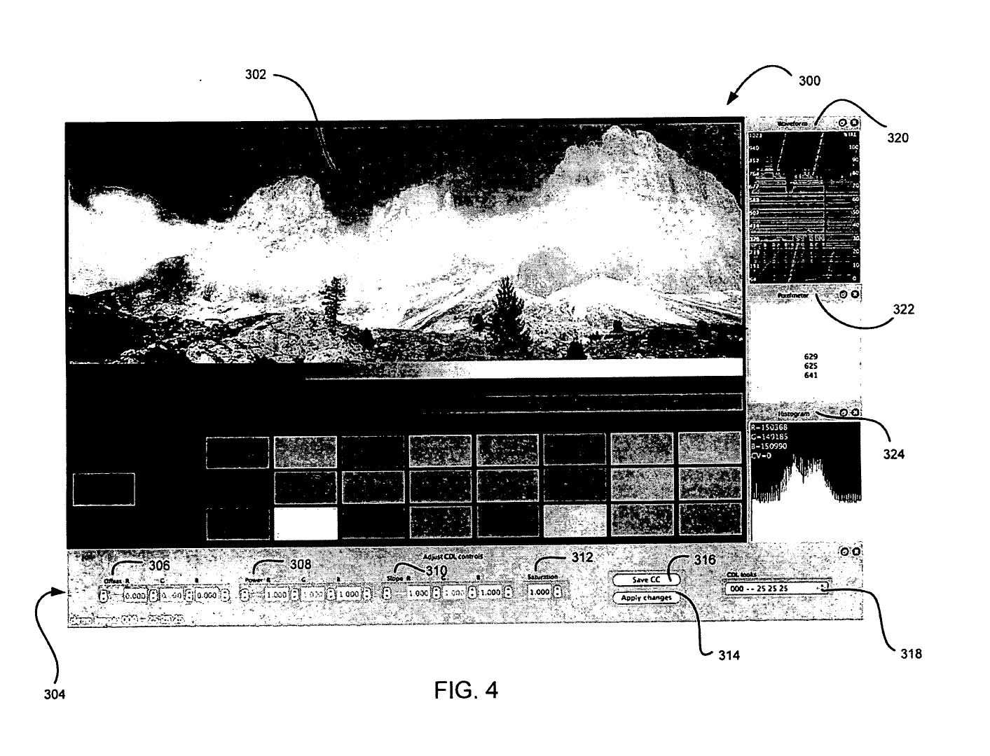

A software program includes a color correction module 114 stored in the memory 110 for color correcting images. The color correction module 114 includes a color grader 116 for adding primary color correction to an image, e.g., a scanned frame of a scene. The color grader 116 will receive the scanned frame, display the image of the frame and enable color manipulations. An exemplary screen shot 300 of the color grader 116 is illustrated in FIG. 4. A first window 302 is provided for displaying the scanned frame. A plurality of controls 304 are provided for applying the color grading to the image. The controls 304 enable adjustment for 10 variables, i.e., CDL parameters, including RGB values for offset 306, RGB values for power to 308, RGB values for slope 310 and a value for saturation 312. The controls 304 further include an apply changes button 314 for applying the adjustments made via controls 306, 308, 310, 312 and a save CC button 316 for saving the color correction (CC) adjustments if satisfactory. Each set of values saved equates to a particular look the Director of Photography is attempting to achieve. A “CDL looks” control 318 list all the looks created and saved by the Director of Photography over the production period of the particular filming, e.g., for a movie, TV show, etc. The CDL looks control 318 is used as a quick way to apply an already created look to a scene as a starting point for further adjustment. For example, when a look is selected, the values for offset, power, slope and saturation are filled in for the selected look and the Director of Photography then only has to adjust any one of the values desired.

The color grader 116 further provides a waveform window 320, pixelmeter window 322 and histogram window 324 employed to visually inspect the image and to ensure the image is balanced, and there is no unwanted clipping occurring. The waveform window 320 displays a level of the image or video signal with respect to time. In this embodiment, the unit used to define video levels is IRE (Institute of Radio Engineers) units or units of brightness levels, where 0% IRE represents total black and 100% IRE represents total white. To ensure the image is balanced, the waveform displayed in the waveform window 320 should lie between 0 and 100% IRE. Alternatively, a histogram is provided as a different way to visually prepare the same data as the waveform. The histogram window 342 illustrates a graph that displays where all of the brightness levels contained in the image are found, from the darkest to the brightest going from left to right. As shown in FIG. 4, the peaks of a histogram of a well-balanced image lie centrally in the histogram window 324. If the peaks of the histogram hit the left or right border of the histogram window 324 clipping or loss of detail may occur in the image. The pixelmeter window 322 displays RGB values, e.g., 10 bit values, of a selected pixel of interest in the image being displayed.

The waveform window 320 and histogram window 324 respond to real-time changes made to the CDL parameters via controls 306, 308, 310 and 312 so that the user, i.e., the birector of Photography, is provided feedback on the manipulations. In this manner, the user can make appropriate manipulations to the CDL parameters to ensure the image is well-balanced. For example, a user can manipulate or adjust the CDL parameters to ensure the waveform displayed in the waveform window 320 lies between 0 and 100% IRE. Correspondingly, manipulations of the user will move horizontally the peaks of the of the histogram shown in the histogram window 324 away from the borders of the window to balance the image.

The color correction module 114 further includes a lookup table (LUT) module 118 for applying a LUT to the image. In one embodiment, the LUT is applied after the color correction as it is a “display LUT”. The LUT is used to limit the color space to print film. The LUT is generated to match a certain print film stock, e.g., Kodak, Fuji, etc. This is necessary if the release of the scene being shot, e.g., a movie, is going back on film. This LUT is not required if the scene being shot would be a pure digital release, e.g., for TV.

A metadata generator 120 generates color correction metadata 122 from the adjustments made via the color grader 116. The metadata 122 is stored and transferred as a CDL in an ASC CDL format. The metadata 122 includes 10 floating point numbers describing Slope, Offset, Power (sometimes called Lift, Gamma, Gain) and saturation. The ASC CDL file format is XML and the file type is “.ccc”. Each corrected image is associated with one set of the ASC-CDL values.

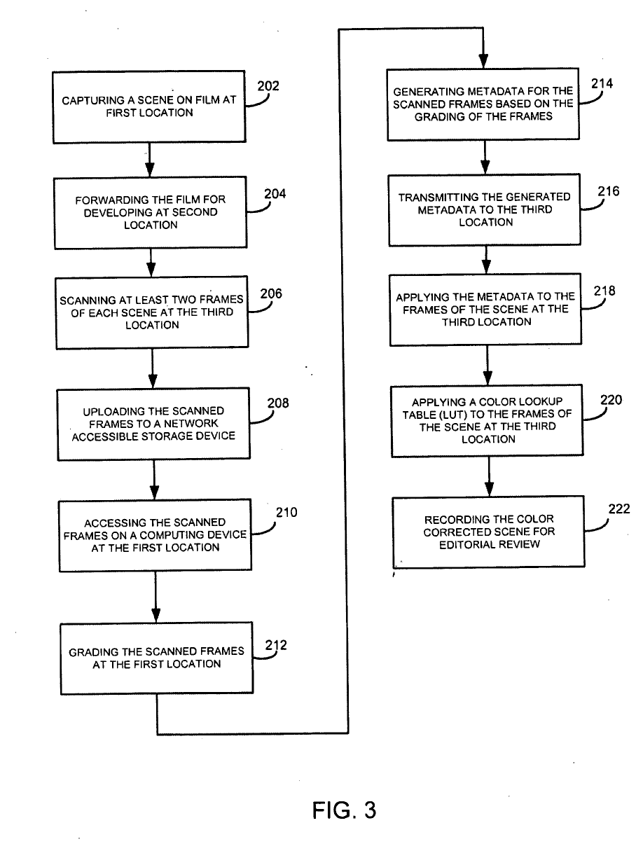

Referring to FIG. 3, a flow diagram of an exemplary method for remote film color correction according to an aspect of the present disclosure is illustrated. Initially, in step 202, a scene or shot is captured on film via a film camera on a set location, i.e., a first location. In one embodiment, the scene is shot or captured on 35 mm film. In step 204, the film camera negative is forwarded to a second location to be developed. The second location may be a film developing laboratory or other suitable facility for developing film.

For each camera roll and for each scene/take/setup, several images are scanned (206). Generally, at least two frames for each scene/take/setup are scanned: a first frame shows a clapperboard used to designate and mark the scene/take/setup to be recorded and a second frame is an image of the actual scene/take/setup being recorded. The clapperboard is a device used to assist in the synchronizing of picture and sound and displays information defining the scene/take/setup being recorded. The information on the clapperboard may include but is not limited to the date, production title, director name and scene information such as a scene number, camera angle and take number. It is to be appreciated that the first frame of the at least two frames includes at least some information identifying the second frame and that information may be shown on devices other than a clapperboard or may be embedded in the first frame.

It is to be further appreciated that the scanning step occurs at a dailies facility, i.e., a third location. In one embodiment, all takes are scanned completely (not only the afore-mentioned 2 frames) at the dailies facility and stored on an appropriate storage device, e.g., a server, until the color correction metadata arrives the next day. In this embodiment, the two frames for each scene/take/setup are extracted from the complete scene to be uploaded.

Once the frames are scanned, the scanned frames are uploaded to an FTP location or other network accessible storage device, such as a server (step 208). It is to be appreciated that the scanning and uploading of the images may be done at the lab 16 or at a separate facility, e.g., a dailies facility, where the developed images are further processed.

From the network accessible storage device, e.g., server 18, the scanned frames are accessed by the Director of Photography on the computing device 102 (step 210), preferably on the filming set location 10, i.e., the first location. The computing device 102 operates in a networked environment using logical connections to one or more remote computers, e.g., server 18. The remote computer may be a personal computer, a server, a router, a network PC, a peer device or other common network node, and typically includes many or all of the elements described above relative to the computing device 102. It is to be appreciated that the network or networked environment may be a local area network (LAN), wide area network (WAN), the Internet or any known network that couples a plurality of computers to enable various modes of communication via network messages. The computing device 102 includes a communication device, i.e., means for accessing and means for transmitting, for enabling communications between the computing device 102 and the remote computers. The communication device may be, but is not limited to, a modem, network interface card (NIC), wireless transceiver, or the like. The computing device 102 may communicate to the server 18 and network via any known communication link, for example, dial-up, hardwired, cable, DSL, satellite, cellular, PCS, wireless transmission (e.g., 802.11a/b/g, etc.), and the like. Furthermore, the devices may communicate using the various known protocols such as Transmission Control Protocol/Internet Protocol (TCP/IP), File Transfer Protocol (FTP), Hypertext Transfer Protocol (HTTP), and the like and secure protocols such as Hypertext Transfer Protocol Secure (HTTPs), Secure Sockets Layer (SSL) Protocol, Secure Electronic Transaction (SEC) Protocol, and the like.

In step 212, the Director of Photography color grades the scanned frames at the first location, i.e., the filming set location 10, via the color grader 116. Based on the manipulations of the Director of Photography, the metadata generator 120 generates metadata for the scanned frames (step 214). Each corrected image is associated with one set of the metadata or ASC-CDL values. It is to be appreciated that the LUT if applied at the computing device 102 is not incorporated into the metadata.

In step 216, the generated metadata is transmitted to the dailies facility, i.e., the third location. As described above, the metadata may be transmitted via FTP transfer, e-mail, or the like. It is to be appreciated that the dailies facility will have an appropriate receiving device for receiving the metadata, e.g., a computer executing an e-mail server/client, an FTP server, or the like. At the dailies facility, the color correction metadata associated to a particular fame of a scene is applied to the scanned frames of the complete scene (step 218).

In step 220, a color lookup table is optionally applied to the frames after the color correction at the dailies facility. The color corrected scene is then recorded to tape/DVD/etc. for editorial review (step 222). It is to be appreciated that the dailies facility is employed for scanning and uploading the DPX files from the film shoot and for applying the ASC-CDL metadata after remote color correction. Each scene from the day before will have the right color grading after the metadata is applied. All graded scenes are then sound synced and recorded to tape/DVD/etc. and send to editorial. In editorial, the film is cut.

The described system and method provides a controlled environment to preview scanned images in the right color space with a calibrated monitor and enables a user, e.g., a Director of Photography to apply ASC-CDL defined manipulations to the scanned images or frames at a remote location. The system and method of the present disclosure also provides a convenient way to keep track and manage all color corrections created during the entire film shoot, via the CDL looks control 318 of color grader 116.

Although embodiments which incorporates the teachings of the present disclosure have been shown and described in detail herein, those skilled in the art can readily devise many other varied embodiments that still incorporate these teachings. Having described preferred embodiments of a system and method for remote film color correction (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

What is claimed is:

1. A method for remote film color correction, the method comprising:
capturing at least one scene on a film negative at a first location (202);
scanning at least two frames from each at least one scene on the film negative at a second location (206);
transmitting the at least two frames to a network accessible storage device (208);
accessing the at least, two frames by a computing device at the first location (210);
grading at least one frame of the at least two frames on the computing device (212);
generating metadata relating to the at least one frame based on the grading step (214); and
transmitting the generated metadata to the second location (216).

2. The method of claim 1, wherein the metadata includes RGB values for offset, RGB values for power, RGB values for slope and a saturation value.

3. The method of claim 2, wherein the metadata is in ASC CDL format.

4. The method of claim 1, further comprising applying the generated metadata to the at least two frames from each at least one scene at the second location (218).

5. The method of claim 4, further comprising applying a color lookup table to the at least two frames from each at least one scene at the second location (220).

6. The method of claim 5, further comprising recording the color corrected at least two frames onto at least one of film and a DVD (222).

7. The method of claim 1, wherein the transmitting the generated metadata is performed by at least one of an e-mail and an FTP transfer.

8. The method of claim 1, wherein the grading step further comprises applying a lookup table including a film print emulation to the at least one frame on the computing device.

9. A system (100) for remote film color correction comprising:
means for accessing over a network at least two frames of at least one scene, the at least two frames being scanned from a film negative including the at least one scene;
a display device (115) for displaying at least one frame of the at least two frames;
a color grader (116) for grading the at least one frame;
a metadata generator (120) for generating metadata relating to the at least one frame based on color correction values received from the color grader (116); and
means for transmitting the generated metadata over the network to a storage device.

10. The system (100) of claim 9, wherein the metadata includes RGB values for offset, RGB values for power, RGB values for slope and a saturation value.

11. The system (100) of claim 10, wherein the metadata is in ASC CDL format.

12. The system (100) of claim 9, further comprising a lookup table module (118) for applying a lookup table including a film print emulation to the at least one frame.

13. The system (100) of claim 9, wherein the color grader (116) generates a waveform (320) for the at least one frame, the waveform (320) being indicative of brightness levels of the at least one frame.

14. The system (100) of claim 9, wherein the color grader (116) generates a histogram (324) for the at least one frame, the histogram (324) being indicative of brightness levels of the at least one frame.

15. The system (100) of claim 9, wherein the color grader (116) generates a pixelmeter (322) for the at least one frame, wherein the pixelmeter (322) displays an RGB value for a selected area of interest on the at least one frame.

16. The system (100) of claim 9, wherein the transmitting means transmits the generated metadata by at least one of an e-mail and an FTP transfer.

17. A program storage device readable by a machine, tangibly embodying a program of instructions executable by the machine to perform method steps for remote film color correction, the method comprising:
accessing over a network at least two frames of at least one scene (210), the at least two frames being scanned from a film negative including the at least one scene;
displaying on a display device at least one frame of the at least two frames;
grading the at least one frame (212);
generating metadata relating to the at least one frame based the grading step (214); and
transmitting the generated metadata over the network to a storage device (216).

18. The program storage device of claim 17, wherein the metadata includes RGB values for offset, RGB values for power, RGB values for slope and a saturation value.

19. The program storage device of claim 18, wherein the metadata is in ASC CDL format.

20. The program storage device of claim 17, the method further comprising applying a lookup table including a film print emulation to the at least one frame.

21. The program storage device of claim 17, the method further comprising generating a waveform for the at least one frame, the waveform being indicative of brightness levels of the at least one frame.

22. The program storage device of claim 17, the method further comprising generating a histogram for the at least one frame, the histogram being indicative of brightness levels of the at least one frame.

23. The program storage device of claim 17, the method further comprising generating a pixelmeter for the at least one frame, wherein the pixelmeter displays an RGB value for a selected area of interest on the at least one frame.

24. The program storage device of claim 17, wherein the transmitting the generated metadata is performed by at least one of an e-mail and an FTP transfer.
